(19) United States
(12) Patent Application Publication
(10) Pub. No.: US 2006/0258497 A1
(43) Pub. Date: Nov. 16, 2006

(54) Tensioner

(76) Inventor: Andrzej Dec, Rochester Hills, MI (US)

Correspondence Address: Jeffrey Thurnau;The Gates Corporation, MS: IP Law Dept. 10-A3, 1551 Wewatta Street, Denver, CO, 80202, US

(21) Appl. No.: 11/128,965

(22) Filed: May 13, 2005

(51) Int. Cl. F16H 7/10; F16H 7/22; F16H 7/08

(52) U.S. Cl. 474/112; 474/109

(57) ABSTRACT

A tensioner comprising a base, an arm pivotally engaged with the base, a pulley journalled to the arm, a spring disposed between the base and the arm, a damping member having an inwardly oriented damping band surface with respect to an axis of rotation (R-R). The damping band surface frictionally engaged with the arm, and having an end (32) connected to the base and another end (31). The damping member disposed radially inward of the spring with respect to an axis of rotation (R-R), and the other end (31) of the damping member is disposed between the spring and the arm. The other end (31) transmits a substantially radial spring force (SF2) with respect to an axis of rotation (R-R) from the spring to the damping band surface.

### FIELD OF THE INVENTION

The invention relates to a tensioner, and more particular, to an eccentric arm tensioner having damping mechanism comprising a spring exerting a spring force by application of a radial pressure on the damping band and having an asymmetric damping characteristic.

### BACKGROUND OF THE INVENTION

Belt tensioners are utilized on vehicle engines in connection with single serpentine belt systems. The belt tensioners include a damping means for preventing undesired oscillations of the tensioner arm. Damping is provided either by a combination of spring force and frictional sliding movement or solely by frictional sliding movement.

It is well known that in many serpentine belt systems the vehicle engine and its systems present variable dynamic conditions. It is desirable in such systems to provide a greater degree of damping. High dynamic loads can be particularly imposed upon belt tensioners in the case where the tensioner is used to maintain an engine timing belt in properly tensioned relation. Special damping arrangements have been developed particularly for tensioners of this type.

Band type damping mechanisms are known for this type of tensioner and service. These are based on the strap or band type brake known in the art. A load is applied to the strap in a direction tangential to the strap frictional surface, for example by a spring. The load applied to the frictional surface generates the frictional load between the strap and the pivot arm which damps movement of the tensioner arm. The band type damping mechanism more tightly grips the tensioner arm in a first direction than the opposite direction. This characteristic provides greater resistance to rotation and hence greater damping in the first direction than in an opposite return rotational direction.

Representative of the art is U.S. Pat. No. RE 34,616 to Komorowski et al. which discloses a belt tensioning device having a damping mechanism for damping movements of the pivoted structure rotatably carrying the pulley with respect to the fixed structure. The damping mechanism includes a strap and a ring mounted on their respective fixed and pivoted structures and with respect to one another such that the strap engages the ring with a gripping action. A spring is included in the mount for enabling the relatively high resistance and relatively low resistance to vary in response to the existence of predetermined vibrations such that the gripping action between strap and ring is relieved sufficient to enable movement therebetween in both directions to take place at substantially reduced resistance levels.

What is needed is a tensioner having damping mechanism comprising a spring that exerts a radial spring force on a damping band by application of a radial pressure on the damping band and having an asymmetric damping characteristic. The present invention meets this need.

### SUMMARY OF THE INVENTION

The primary aspect of the invention is to provide a tensioner having damping mechanism comprising a spring that exerts a radial spring force on a damping band by application of a radial pressure on the damping band.

Another aspect of the invention is to provide a tensioner having an asymmetric damping characteristic.

Other aspects of the invention will be pointed out or made obvious by the following description of the invention and the accompanying drawings.

The invention comprises a tensioner comprising a base, an arm pivotally engaged with the base, a pulley journalled to the arm, a spring disposed between the base and the arm, a damping member having an inwardly oriented damping band surface with respect to an axis of rotation (R-R). The damping band surface frictionally engaged with the arm, and having an end (32) connected to the base and another end (31). The damping member disposed radially inward of the spring with respect to an axis of rotation (R-R), and the other end (31) of the damping member is disposed between the spring and the arm. The other end (31) transmits a substantially radial spring force (SF2) with respect to an axis of rotation (R-R) from the spring to the damping band surface.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a semi-schematic plan view of the damping mechanism.

FIG. 2 is an exploded side view of the tensioner.

FIG. 3 is a perspective exploded view of the tensioner.

### DETAILED DESCRIPTION OF THE PREFERRED EMBODIMENT

The inventive tensioner and damping mechanism comprise an eccentric type tensioner. The tensioner is used to impart a belt load on a power transmission belt. During operation of the belt system, the belt position will fluctuate depending on changes in load as well as changes in the load direction. Load changes as well as irregularities in the belt system will cause the tensioner arm to oscillate. The oscillations are damped by the damping mechanism. The inventive damping mechanism imparts an asymmetric damping characteristic, meaning a damping force in a tensioner arm loading direction is greater than a damping force in a tensioner arm unloading direction.

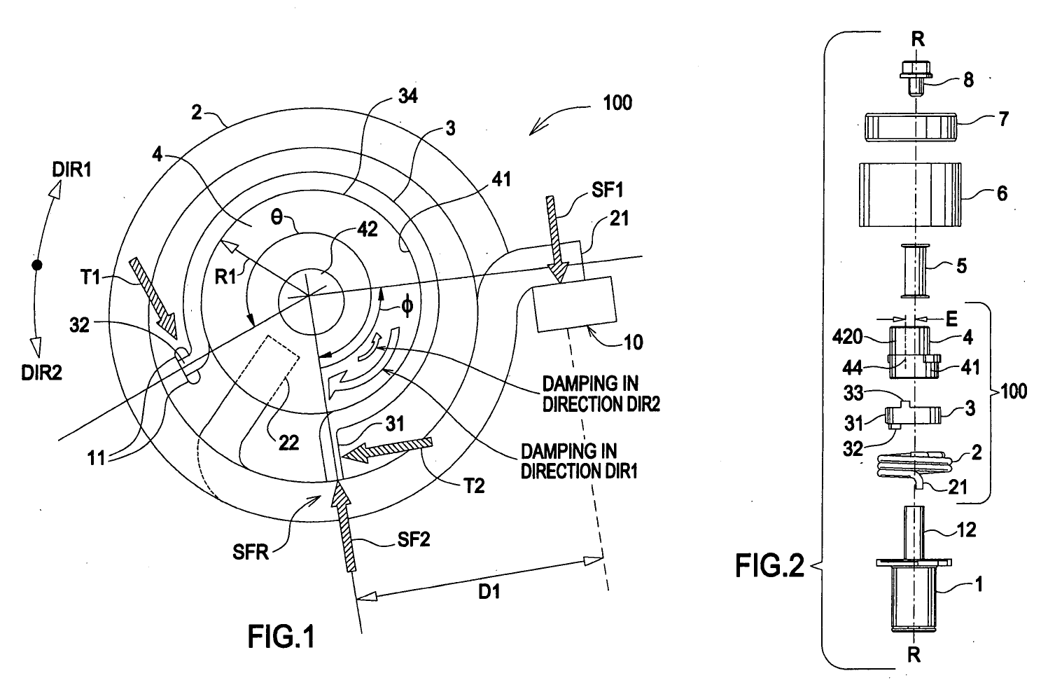

FIG. 1 is a semi-schematic plan view of the damping mechanism. Damping mechanism 100 is contained within the perimeter of the tensioner, namely within the perimeter of pulley 6, see FIG. 2. Damping mechanism 100 generally comprises a damping band 3, torsion spring 2, and surface 41 of arm 4. Torsion spring 2 is disposed radially outward of tensioner arm 4 and damping band 3. Damping band 3 frictionally bears upon tensioner arm 4. Damping band 3 damps oscillations of tensioner arm 4 during operation of the tensioner.

Damping band surface 34 is slidingly engaged with an outer surface 41 of tensioner arm 4, see FIG. 2. Damping band 3 has a radius R1 when in contact with surface 41 and is disposed radially inward of spring 2 with respect to an axis of rotation (R-R). Surface 34 of damping member 3 comprises a cylindrical, inwardly curved arcuate surface with respect to an axis of rotation (R-R). Damping band 3 wraps about arm 4, whereby surface 34 engages surface 41. Surface 34 and surface 41 each have a coefficient of friction. In the preferred embodiment damping band 3 comprises a plastic coated spring steel band. The plastic coating comprises the frictional material having a coefficient of friction. The plastic coating may comprise polyurethane, nylon, and PTFE as well as combinations of the foregoing. In an alternate embodiment the plastic coating is omitted and the damping band metallic material bears directly upon surface 41. Damping band 3 also comprises a spring function and spring rate whereby surface 34 is pressed into engagement with surface 41. A relaxed radius of damping band 3 is somewhat less than radius R1 to assure proper contact of surface 34 with surface 41.

A first end 31 of damping band 3 contacts torsion spring 2. End 31 extends substantially normally in a radial direction with respect to R-R to engage the coils of torsion spring 2 at a reaction point (SFR). End 31 is also disposed substantially in the plane of coils 23, the plane extends normally to axis R-R. End 31 is not otherwise connected, fixed or fastened to torsion spring 2; end 31 simply bears upon the spring as shown in FIG. 2. End 32 of damping band 3 is engaged with tensioner base 1 at retaining portion 11. Retaining portion 11 holds end 32 in a fixed position on base 1.

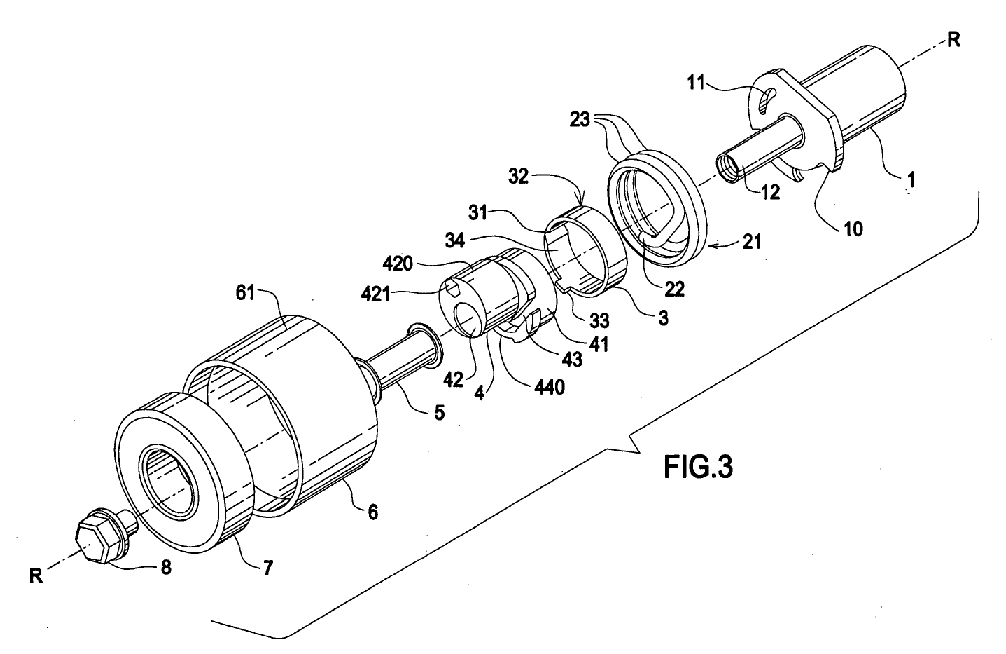

A first end 21 of torsion spring 2 is engaged with portion 10 of tensioner base 1. A second end 22 of torsion spring 2 is engaged with tensioner arm 4 in receiving portion 43, see FIG. 3. Portion 10 holds end 21 in a fixed position with respect to base 1. Portion 10 may comprise either a slot or hole in base 1 or a projection with equal effect. Portion 10 comprises a structural feature on the base to react with SF1.

In operation, torsion spring 2 transmits a spring force through pulley 6 to a belt (not shown) to load the belt. In so doing a spring reaction force SF1 is realized on portion 10.

End 31 of damping band 3 is exposed to a spring reaction force SF2 due to contact with the spring coils at a spring force reaction point, i.e. contact position (SFR). Spring force SF2 is generated by the partial radial contraction of spring 2 as spring 2 is loaded during operation by pivotal movement of arm 4. As the tensioner arm is loaded it rotates in direction DIR1. Loading spring 2 causes the coils to “wind-up” or contract.

As the spring contracts, spring reaction force SF2 presses end 31 inward, thereby increasing the force pressing surface 34 into contact with surface 41. Spring reaction force vector SF2 is substantially radial with respect to a tensioner axis of rotation (R-R), see FIG. 2. This in turn increases the frictional force between the damping band surface 34 and the tensioner arm surface 41, which in turn increases the damping force on arm 4. The damping force is a function of the frictional force between the damping band surface 34 and surface 41.

The frictional force is subject to the amount of wrap (θ) of band 3 about arm 4, see equation (4). The damping force damps oscillations of the tensioner arm 4 caused during operation of the belt system of which the tensioner is a part.

As the tensioner arm is unloaded it moves in direction DIR2. The torsion spring coils relax somewhat thereby radially expanding, which in turn decreases spring reaction force SF2. This decreases the frictional force between the damping band surface 34 and the tensioner arm surface 41, and hence the damping force exerted on arm 4.

Hence, the frictional force resisting rotation of arm 4 is greater in a loading direction (DIR1) than in an unloading direction (DIR2), which gives an asymmetric damping characteristic. The asymmetric damping characteristic can also be characterized in terms of a coefficient of asymmetry.

The inventive tensioner coefficient of asymmetry is in the range of approximately 1.1 to approximately 5.0. The coefficient of asymmetry can be determined by proper selection of the component variables as described herein.

More particularly, according to Euler's equation the disclosed arrangement produces asymmetric damping which varies in magnitude depending upon the direction of rotation of tensioner arm 4. The magnitude of the damping force in each direction can be controlled by the amount of wrap angle (θ) of the damping band about the tensioner arm; the damping band (34) material coefficient of friction (μ); the spring force (SF2); and the angular position (φ) of the reaction point (SFR) versus end 21.

For example, the following calculation is presented to illustrate the principles of the invention, but is not offered by way of limitation. Please refer to FIG. 1.

Direction of Shaft Rotation: Direction DIR1

1) Total Friction Force in shaft rotation direction DIR1=FRICTION1 DIR1+FRICTION2 DIR1
2) FRICTION1 DIR1=SF2×μ
   where
   μ is the coefficient of friction of surface 34; and vector SF2 is the radial spring force exerted by spring 2 on damping band end 31.
3) FRICTION2 DIR1=T1−T2
   where T1 is the tangential force on end 32; and
   T2 is the tangential force on end 31
4) T1=T2×(e^{μθ})
   where θ is the angular separation of ends 31, 32.
5) If μ=0.15 and θ=270° then e^{μθ}=2; so from
4) T1=2(T2)
   solving;
6) FRICTION2 DIR1=2(T2)−T2=T2
7) and T2=SF2×μ
   therefore
8) Total Friction in Direction DIR1=(SF2×μ)+(SF2×μ)=2SF2×μ
   Direction of Shaft Rotation: Direction DIR2

Damping band 3 cannot be tensioned by friction. When shaft 4 rotates in direction DIR2, the total friction force is developed by spring force SF2, therefore,
9) Total Friction Force in direction DIR2=SF2×μ
   Calculation of Spring Force (SF2)
10) SF1+SF2=0; SF1=−SF2
11) SF1×D1=Spring Torque
   If Spring Torque=2 Nm, and R1=15 mm=0.015 m, the resulting spring force is:
(12) SF1=2/0.015=133 N
   Friction Torque:
If the coefficient of friction μ is 0.15:
Total Friction in Direction DIR1=2×133×0.15=40 N
Total Friction in Direction DIR2=133×0.15=20 N
Friction Torque in Direction DIR1=Total Friction in
Direction DIR1×R1=40 N×0.012 m=0.48 Nm
Friction Torque in Direction DIR2=Total Friction in
Direction DIR2×R1=20 N×0.012 m=0.24 Nm
   Coefficient of Asymmetry:
[Friction Torque in Direction DIR1]/[Friction Torque in Direction DIR2]
Solving: 0.48/0.24=2.0

The friction torque is the total friction in a given direction multiplied by the radius at which the friction is being applied with respect to the axis R-R. The ratio of the friction torque in the loading direction with respect to the unloading direction is the coefficient of asymmetry. The coefficient of asymmetry for a particular application can be designed by appropriate selection of the foregoing variables.

The amount of wrap angle (θ) of the damping band about the tensioner arm is in the range of approximately 45° to approximately 360°. The angular position (φ) of the reaction point (SFR) compared to spring end 21 is in the range of approximately 0° to approximately 180°. The coefficient of friction (μ) of surface 34 is in the range of approximately 0.10 to approximately 0.50.

FIG. 2 is an exploded side view of the tensioner. The inventive tensioner comprises a base 1, with which torsion spring 2 is engaged at end 21. Damping band 3 is concentrically disposed about tensioner arm 4.

Bushing 5 is disposed in hole 42, see FIG. 3, in tensioner arm 4. Bushing 5 engages post 12, thereby allowing tensioner arm 4 to pivot about post 12 when the tensioner is in operation. Bushing 5 comprises bearing materials known in the art, including but not limited to polyurethane, nylon and PTFE. The bushing material may also comprise a lubricant such as graphite. In this embodiment bushing 5 comprises Norglide™, namely, plastic coated steel.

Pulley 6 is journalled to tensioner arm 4 by way of bearing 7. Bearing 7 engages tensioner arm 4 at surface 420. Pulley 6 rotationally engages a belt (not shown) in a manner known in the art, for example, engages a power transmission belt on a vehicle engine.

The center of curvature 44 of circular surface 420 is eccentrically offset a distance (E) from tensioner arm axis of rotation (R-R), thereby providing the moment arm necessary for application of the spring force to the belt. Arm 4 may also be referred to as an eccentric arm.

Fastener 8 is engaged with post 12 to hold the components together. Fastener 8 may comprise a bolt as shown, or any other suitable fastener known in the art.

Damping band surface 34, see FIG. 1, frictionally engages surface 41 of arm 4. Surface 41 comprises a coefficient of friction in the range of approximately 0.10 to approximately 0.50. Arm 4 and surface 41 comprise a metallic material such as aluminum or steel, or other equivalent material known in the art.

FIG. 3 is a perspective exploded view of the tensioner. End 22 engages receiving portion 43 in tensioner arm 4. Receiving portion 43 comprises a slot in this embodiment, although any manner of attaching or connecting end 22 to arm 4 consistent with operation of the tensioner would be acceptable. End 21 of spring 2 engages base 1 at portion 10. Damping band surface 34 is substantially cylindrical with surface 34 oriented inward toward axis R-R.

Pulley surface 61 is flat, but may also comprise any suitable profile such as ribbed or toothed to engage a similarly profiled belt. Bearing 7 comprises a ball bearing in this embodiment. End 32 of damping band 3 engages portion 11 of base 1. In this embodiment portion 11 comprises a slot, but is may also comprise a projection. Portion 33 engages portion 440 of tensioner arm 4 which acts as a travel stop should the travel range of the arm 4 be exceeded during operation.

Spring 2 comprises a torsion spring having spring coils 23. Spring 2 comprises a spring rate (k) which is selected in a manner known in the art to accommodate a desired belt load for a given belt drive system.

Receiving portion 421 is used to engage a tool (not shown). For example, the tool may comprise a ⅜″ ratchet tool known in the art. In this embodiment receiving portion 421 comprises a hexagonal hole. The tool is used to rotate arm 4 to preload the tensioner during installation, namely, during installation tensioner arm 4 is turned in DIR1 somewhat beyond a normal operating position. After the belt is routed around the tensioner, arm 4 is released thereby causing the arm 4 to bear upon and load the belt.

Although forms of the invention have been described herein, it will be obvious to those skilled in the art that variations may be made in the construction and relation of parts without departing from the spirit and scope of the invention described herein.

I claim:

1. A tensioner comprising:
a base;
an arm pivotally engaged with the base;
a pulley journalled to the arm;
a spring disposed between the base and the arm;
a damping member having an inwardly oriented damping band surface with respect to an axis of rotation (R-R), the damping band surface frictionally engaged with the arm, and having an end (32) connected to the base and another end (31);
the damping member disposed radially inward of the spring with respect to an axis of rotation (R-R); and
the other end (31) of the damping member is disposed between the spring and the arm, the other end (31) transmits a substantially radial spring force (SF2) with respect to an axis of rotation (R-R) from the spring to the damping band surface.

2. The tensioner as in claim 1, wherein the tensioner has an asymmetric damping characteristic.

3. The tensioner as in claim 1, wherein the damping member further comprises an angle of wrap (O) about the arm in the range of approximately 45° to approximately 360°.

4. The tensioner as in claim 2, wherein the asymmetric damping characteristic is in the range of approximately 1.1 to approximately 5.

5. The tensioner as in claim 1, wherein the damping force is greater in an arm loading direction than in an arm unloading direction.

6. The tensioner as in claim 1, wherein the spring comprises a torsion spring.

7. The tensioner as in claim 1, wherein:
the spring comprises a coil; and
the other end (31) is disposed substantially normal to the coil in a radial direction toward axis R-R.

8. A tensioner comprising:
a base;
an eccentric arm pivotally engaged with the base;
a pulley journalled to the eccentric arm;
a torsion spring disposed between the base and the eccentric arm;
a damping member having a frictional surface (34) in frictional engagement with the eccentric arm, and having a first end (31), the first end engaged between the torsion spring and the eccentric arm and a second end (32) engaged with the base, the first end transmitting a substantially radial spring force (SF2) to the frictional surface;
the damping member further comprises an angle of wrap (θ) about the eccentric arm in the range of approximately 45° to approximately 360°; and
the damping member having a coefficient of asymmetry.

9. The tensioner as in claim 8, wherein the coefficient of asymmetry is in the range of approximately 1.1 to approximately 5.

10. The tensioner as in claim 8, wherein:
the damping member has a substantially cylindrical shape; and
the frictional surface is oriented inwardly toward an axis R-R.
